(19) United States
(12) Patent Application Publication
(10) Pub. No.: US 2006/0087934 A1
(43) Pub. Date: Apr. 27, 2006

(54) Apparatus for processing data stored on a data carrier having some defects and method of method of processing data on such a disc

(75) Inventors: George A. Leenknegt, Paris (FR); Frebus J. Van Slochteren, Utrecht (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhove (NL)

(21) Appl. No.: 10/532,935

(22) PCT Filed: Oct. 10, 2003
(86) PCT No.: PCT/IB03/04532

§ 371 Date: Apr. 27, 2005

(30) Foreign Application Priority Data
Oct. 30, 2002 (EP) 02292710.7

(51) Int. Cl. G11B 7/00

(52) U.S. Cl. 369/44.32; 369/53.15

(57) ABSTRACT

The apparatus comprises an emulator 62, which emulates the functions of the actuator 20, which moves the optical system used for the processing of data on the data carrier. By this measure the defects that the carrier may comprise provides less disturbance for the user. Application: the invention is well suited for optical discs containing some defects.

The present invention relates to an apparatus for processing data placed on tracks on a data carrier which may have defects, the apparatus using a laser beam guided on said tracks by a servomechanism.

The invention also relates to a method of processing data on a disc, which may have defects.

Data carriers, such as optical discs, may have many defects if they are manufactured in a way so that they are very cheap. It is important for the user who uses these cheap optical discs, not to be disturbed too much.

Some measures have been proposed to remedy these defects. U.S. Pat. No. 6,259,663 provides some of them.

The invention proposes an apparatus for which the defects do not cause iconsiderable losses of tracking by using other measures than those disclosed in said US patent.

Therefore, such an apparatus according to the invention is defined by the following:

It is an apparatus for processing data placed on tracks on a data carrier which may have defects, the apparatus using a laser beam, the apparatus comprising:
a servomechanism for guiding a laser beam on said tracks by acting on a moving part that controls the laser beam,
a controller device for controlling said moving part,
an emulator which has an electrical behavior similar to said moving part,
defect detector for providing a defect signal for the defects on said carrier,
a switch controlled by said defect signal for applying the output of the emulator to the input of the controller device.

In the scope of the invention an emulator is known by the name of “observer”.

According to the invention, a method of processing data on a disc which may have defects, the method involving the following steps of:
guiding a laser beam on said tracks by acting on a moving part which controls the direction of the laser beam,
controlling said moving part by a controller device,
using an emulator (observer) which has a similar electrical behavior to said moving part,
providing a defect signal for the defects on said carrier,
applying the output of the emulator to the input of the controller device.

These and other aspects of the invention are apparent from and will be elucidated by way of non-limitative example with reference to the embodiment(s) described hereinafter.

In the drawings:

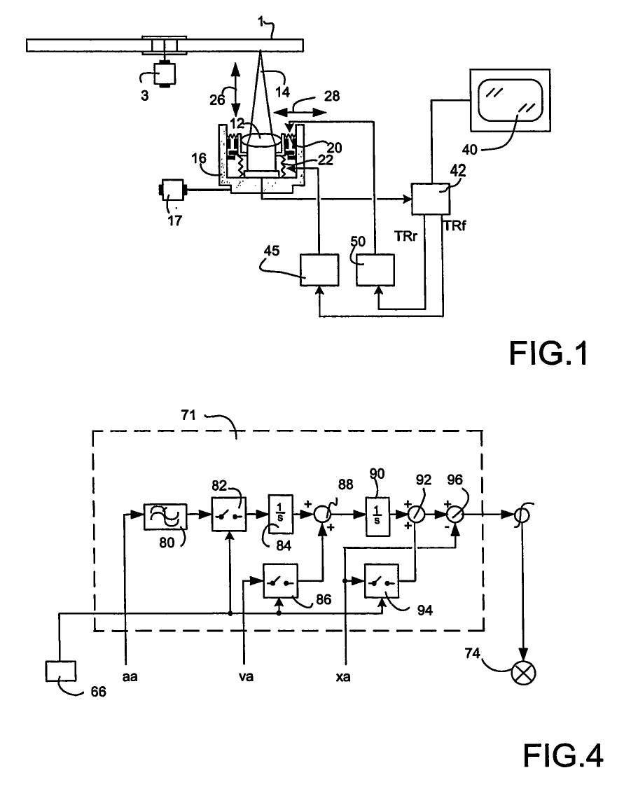

FIG. 1 shows an apparatus in accordance with the invention,

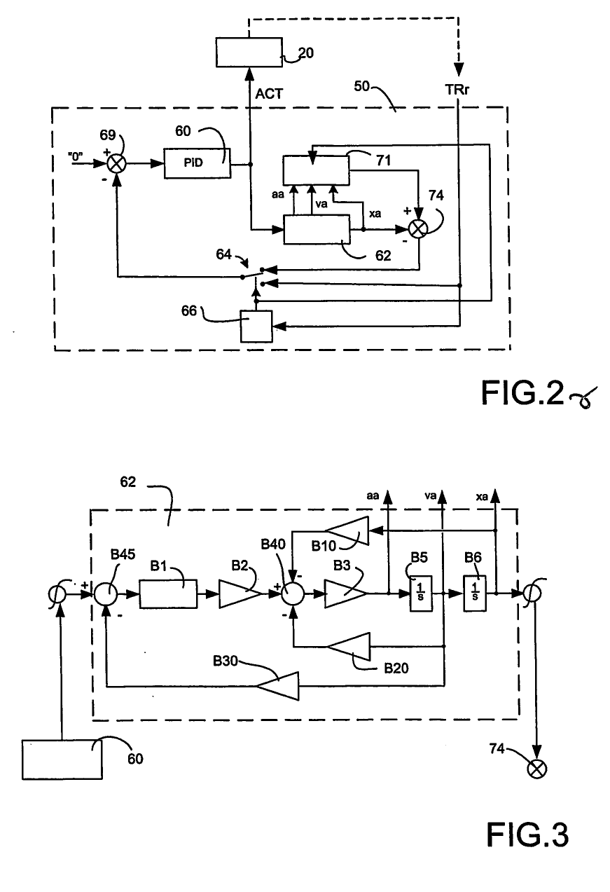

FIG. 2 shows a scheme of a radial guidance device used by the apparatus of FIG. 1.

FIG. 3 shows a scheme of an emulator used by the apparatus of FIG. 1,

FIG. 4 shows a scheme of a predictor device used by the apparatus of FIG. 1.

FIG. 1 shows an apparatus, in which a data carrier 1 is placed. This data carrier may be an optical disc. In FIG. 1 the carrier is shown in cross section. A disc motor 3 rotates the carrier. A lens 12 focuses a laser light beam 14 on this carrier. The laser is mounted in a sledge 16 which can be moved along the radius of the carrier in dependence on the control of electronic circuits, not shown in the Figure, acting on a sledge motor 17. Inside this sledge, little movements are allowed thanks to actuator devices. There are actuator devices for the radial positioning referred to as 20 and for focus positioning, referred to as 22. Arrow 26 indicates the directions of focus positioning and the arrow 28 indicates the directions of radial positioning. The actuator is formed by electrotechnical elements, such as coils, magnet return springs and so on. The sledge contains also photodetectors, which produce signals. These signals are used, on the one hand for the displaying of pictures on a screen 40, for instance, and on the other hand for controlling various servos. A spliter device 42 directs these signals to the relevant further devices. Among them, a signal TRf is used for the focusing via a focusing device 45 and another TRr for the radial positioning via the radial guidance device 50.

The FIG. 2 shows in more detail the radial guidance device 50 in which provisions are made for avoiding the bad effects of the defects which may be present on the data carrier. This device 50 includes a PID controller 60. This controller applies a control signal to the actuator device 20. The functions of this controller are to provide a gain (proportional) action, an integral action and a differential action, which are well known in the state of the art. The input signal of this controller is an error signal representing the guidance error of the laser beam. This signal is either the signal TRr or the output signal of an emulator 62. The choice of the signal is determined by the position of a switch 64 controlled by a defect detector 66. A comparator 69 comparing the signal at the output of the switch 64 with the “0” value reminds one that it must be kept constant with a value near “0”. For improving the behavior of the emulation, a predictor device 71 is provided. Its output signal is combined with the output signal of the emulator 62 by a substractor 74 for forming an error signal used for the duration for which a defect is detected. The defect detector analyses the signal at the output of said defect detectors. A defect is declared when the light intensity drops rapidly (<1.5 ms) to approximately 75% of its nominal value.

FIG. 3 shows in more detail the electrical structure of the emulator 62. Processor and software can emulate this structure, as usual. The boxes, which are shown in the FIG. represent various physical parameters of the actuator device 20. The box B1 represents the response of the coil and the magnet that the actuator comprises. The transfer function H1 of this box B1 can be written as:

$$H 1 = \frac{1}{LR . s + Rr}$$

Where LR is the inductance of the coil and Rr is its resistor.

The box B2 represents the force, which is applied when a voltage is present at the input of the box B1. Its transfer function H2 can be written as:
H2=Kf

Where Kf is a constant.

The box B3 represents the influence of the mass of the lens m_lens that the actuator device moves. Its transfer function H3 can be written as:
H3 =1/m_lens

At the output of box B3, an estimate of the acceleration “aa” of the moving of the actuator device is given. Then by two integrators B5 and B6 it is possible to obtain the estimates of the speed “va” and the position “xa” of the moving part. The box B10 represents an elastic constant K provided by a return spring, the box B20 a damping constant Dp and the box B30 an electromagnetic force Emk. A box B40 represents the adding of the value at the output of the box B2 minus the values at the outputs of B10 and B20. The input values of B10 and B20 are the output values of B6 and B5 respectively. A box B45 defines a subtraction of the value provided by the box B30 at the value applied to the input of the device 62. The input value of B30 is the value elaborated by the box B6. The output of B6 constitutes the output of the device 62.

FIG. 4 shows the structure of the predictor device 71. A first input of this device receives the signal “aa”. The filter 80 filters this signal so as to smoothe it. A sample-and-hold device 82 sotres the value of the filtered signal when the detector 66 detects a defect. An integrator 84 integrates this value so as to provide a speed which is combined with the value “va” coming from another sample-and-hold device 86. An adder 88 performs the combining. The combined speed is integrated by an integrator 90 so as to form a position value which is combined with the value “xa” by an adder 92. A sample-and-hold device 94 also stores the value “xa”. Finally, the output signal of the device 71 is formed by a substractor 96.

The scope of the invention concern also the servo mechanism which is embedded in the focusing device 45. This device comprises the same elements that the device 50, notably an emulator which keeps the focusing when a defect on the disc appears.

The process of focusing must be started before the radial guidance process.

1- An apparatus for processing data placed on tracks on a data carrier which may have defects, the apparatus using a laser beam, the apparatus comprising:
a servomechanism for guiding a laser beam on said tracks by acting on a moving part that controls the laser beam,
a controller device for controlling said moving part,
an emulator which has an electrical behavior similar to said moving part,
a defect detector for providing a defect signal for the defects on said carrier,
a switch controlled by said defect signal for applying the output of the emulator to the input of the controller device.

2- An apparatus as claimed in claim 1 wherein the servomechanism acts on radial direction.

3- An apparatus as claimed in claim 1 or 2 wherein the servomechanism acts on focusing the laser beam.

4- A method of processing data on a disc which may have defects, the method involving the following steps of:
guiding a laser beam on said tracks by acting on a moving part which controls the laser beam,
controlling said moving part by a controller device,
using an emulator which has a similar electrical behavior to said moving part,
providing a defect signal for the defects on said carrier,
applying the output of the emulator to the input of the controller device.

5- A method as claimed in claim 4, the guiding comprising a step for the guidance concerning the radial direction.

6- A method as claimed in claim 4 or 5, the guiding comprising a step for the focusing of the laser beam.
